(19) United States
(12) Patent Application Publication
(10) Pub. No.: US 2025/0054679 A1
(43) Pub. Date: Feb. 13, 2025

(54) COIL COMPONENT, COIL DEVICE, AND METHOD FOR PRODUCING COIL COMPONENT

(71) Applicant: SUMIDA CORPORATION, Tokyo (JP)

(72) Inventors: Hiroshi KAWASHIMA, Miyagi (JP); Junji MORITA, Miyagi (JP); Daichi GEMBA, Miyagi (JP)

(73) Assignee: SUMIDA CORPORATION, Tokyo (JP)

(21) Appl. No.: 18/718,330

(22) PCT Filed: Jan. 26, 2022
(86) PCT No.: PCT/JP2022/002826

§ 371 Date: Jun. 10, 2024

(51) Int. Cl. H01F 27/28; H01F 41/061

(52) U.S. Cl. CPC H01F 27/28; H01F 41/061

(57) ABSTRACT

A coil component, in which the axial direction length including a gap and a coupling part of two coil elements is shortened for size reduction, and deterioration in characteristics and the risk of heat generation that could occur when the leakage magnetic flux comes into contact with a twisted portion can be reduced; a coil device; and a method for producing the coil component. The component includes: first and second coil elements formed from a coil winding body obtained by rectangularly stacking one rectangular wire in an edge-wise manner, which is divided into two and folded back, and in which the opposing side surfaces of the are disposed to be parallel and in close contact; and a coupling part that couples the coil elements, which straddles the upper surfaces of both coil elements. The coupling part includes, at one portion, a twisted section where the rectangular wire is twisted 180°.

### TECHNICAL FIELD

The present invention relates to a coil component used as a reactor or the like and a method for producing the coil component, and specifically to a coil component including two laminated coils with angular-tubular shapes which are formed of one rectangular wire and are disposed adjacent to each other, a coil device, and a method for producing the coil component.

### BACKGROUND ART

A coil component such as a reactor can generate an inductance with a configuration in which a winding coil is wound around a magnetic core.

Various types of reactors in accordance with purposes of utilization, such as a reactor with a large capacitance for a power transmission system and a reactor as a component of a communication apparatus, are known. Such reactors are accommodated in metal cases or the like along with other insulating members and the like.

Incidentally, a configuration of a reactor used in an in-vehicle booster circuit in which two laminated coil elements are formed in parallel and are connected such that electric currents flowing through both the coil elements flow in mutually opposite directions in order to obtain a high inductance value in a case where a high electric current is caused to flow is known (see Patent Literature 1 listed below, for example).

In other words, in Patent Literature 1, a first coil element and a second coil element obtained by rectangular wires being wound in an edge-wise manner while producing bent portions are formed in parallel at opposing positions of a magnetic core configuring a closed loop. A coupling part of the rectangular wires is twisted by 180 degrees at the time of straddling the two coil elements.

As another related art based on a gist similar to that of Patent Literature 1 listed below, a related art that is different from Patent Literature 1 listed below in that coil elements have angular shapes and in that a coupling part connecting the two coil elements is provided in front of lateral sides of the two coil elements is also known (see Patent Literature 2 listed below).

### CITATION LIST

### Patent Literature

Patent Literature 1: Japanese Patent Laid-Open No. 10-172852
Patent Literature 2: Japanese Patent Laid-Open No. 2019-153722

### SUMMARY OF INVENTION

### Technical Problem

According to Patent Literature 1 listed above, the rectangular wires at the coupling part get in between the opposing side surfaces of the two coil elements and are passed from one of the coil elements to the other coil element, it is thus not possible to bring both the coils into close contact with each other, and the gap between the coil elements increases by any means, which is contrary to a requirement for device size reduction.

Also, since the twisted portion at the coupling portion is located in the path of the leakage magnetic flux in the magnetic coupling-type reactor, there is a problem that heat generation is likely to occur.

Note that although the gap between the two coil elements can be solved in Patent Literature 2 listed above as compared with Patent Literature 1 listed above, and the twisted portion separated from the path of the leakage magnetic flux can solve the problem of heat generation, which is preferable, further size reduction is required for the axial direction length including the coupling part of the coil elements.

The present invention was made in view of such circumstances, and an object thereof is to provide a coil component capable of achieving size reduction by shortening an axial direction length including a gap and a coupling part between two coil elements and capable of reducing a risk of heat generation due to a leakage magnetic flux hitting a twisted portion, a coil device, and a method for producing the coil element.

### Solution to Problem

In order to solve the above problem, a coil component, a coil device, and a method for producing a coil component according to the present invention include the following features.

In other words, a coil component according to the present invention includes: a first coil element and a second coil element that are formed from a winding coil divided into two and folded back at a predetermined position with opposing side surfaces disposed to be parallel with each other, the winding coil being formed by rectangularly laminating one rectangular wire in an edge-wise manner; and a coupling part that couples both the coil elements, in which for the coupling part, when, in end surfaces related to the coupling between the first coil element and the second coil element, a side of the first coil element and a side of the second coil element adjacent to each other among each of sides of a rectangular part configuring the end surfaces of each of the coil elements, and sides that are parallel to the sides, are referred to as first sides, the coupling part is for coupling a coil element winding end portion located in a vicinity of an end portion of one of the first sides of one of the two coil elements or on an extension of the first side with a coil element winding start portion located in a vicinity of an end portion of one of the first sides of the other one of the two coil elements or on an extension of the first side, and the coupling part is disposed to straddle the first coil element and the second coil element by being caused to follow upper surfaces of the two coil elements with a predetermined gap from the upper surfaces, and is configured to include a twisted section where the rectangular wire is twisted by 180 degrees at one portion of the coupling part.

Note that the above “upper surfaces” refer to coil surfaces that are parallel with a plane including both an alignment direction of the two coil elements and an axial direction of the two coil elements.

Also, it is preferable that for the coupling part, when the first sides of the first coil element and the second coil element located on an inner side are referred to as inner first sides, and the first sides located on an outer side are referred to as outer first sides, the coupling part be for coupling one of a coil element winding start portion and a coil element winding end portion located in a vicinity of an end portion of one of the inner first side of one of the two coil elements or on an extension of the inner first side with the other one of the coil element winding start portion and the coil element winding end portion located in a vicinity of an end portion of one of the outer first side of the other one of the two coil elements or on an extension of the outer first side.

In this case, it is preferable that the coupling part includes two sides in a length direction of the first coil element and the second coil element and one side in an alignment direction of the coil elements, the two sides having a predetermined length and extending in an axial direction of the coil elements via flat-wise folded portions from the coil element winding start portion and the coil element winding end portion on upper surfaces of the coil elements, the one side connecting end portions of the two sides in the length direction, the twisted section being provided on a side extending from the inner first side out of the two sides in the length direction.

Also, it is preferable that in the first coil element and the second coil element, end portions of the rectangular wire on sides opposite to the coupling part be formed to extend upward from a side of the upper surface.

Also, it is preferable that opposing side surfaces of the first coil element and the second coil element be configured to be in close contact with each other.

Moreover, a coil device according to the present invention includes: any of the aforementioned coil components; and a magnetic core part with leg parts inserted into hollow parts of the coil component to form a closed magnetic path as a whole.

Also, a method for producing a coil component according to the present invention including a first coil element and a second coil element that are formed into angular-tubular shapes in a mutually aligned manner by using one rectangular wire with both end portions serving as connection terminals and laminating portions in vicinities of both the end portions in an edge-wise manner, and a coupling part that couples both the coil elements, opposing one side surface of the first coil element and one side surface of the second coil element being disposed to be parallel with each other includes, in a case where sides configuring the angular-tubular shapes are referred to as lateral sides in a direction parallel with an alignment direction connecting centers of the first coil element and the second coil element and as long sides in a direction perpendicularly intersecting the alignment direction in a state where the coil component is produced: a first coil element forming step of forming the first coil element into an angular-tubular shape by winding and laminating the rectangular wire in an edge-wise manner including the longitudinal sides and the lateral sides from a vicinity of an end portion of the first coil element of the rectangular wire; a coupling part forming step of forming a longitudinal side extended part of the first coil element by causing the rectangular wire to stick out in an outer diameter direction of the angular-tubular shape to extend the longitudinal side from a winding terminating end of the first coil element, further forming a coupling part lateral side that is parallel with the lateral sides by folding the longitudinal side extended part by 90 degrees in an edge-wise manner to be directed to an upper surface of the second coil element, and then forming a longitudinal side extended part of the second coil element to be parallel with the longitudinal side extended part of the first coil element and continue to a winding start end of the second coil element by folding the coupling part lateral side by 90 degrees toward the second coil element in an edge-wise manner; a second coil element forming step of forming the second coil element into the angular-tubular shape by winding and laminating the rectangular wire in a same direction as a winding direction of the first coil element up to a vicinity of the other end portion in an edge-wise manner including the longitudinal sides and the lateral sides at a position where the second coil element is produced, each of the steps being performed in this order; a coil element splitting step of subsequently twisting the longitudinal side extended part of the first coil element by 180 degrees at a position of the coupling part and folding back the first coil element and the second coil element in a mutually two-folded form in a direction perpendicularly intersecting the alignment direction; and a coupling part folding step of then folding the longitudinal side extended part of the first coil element and the longitudinal side extended part of the second coil element by 90 degrees in a flat-wise manner at positions mutually separated from upper surfaces of the first coil element and the second coil element by a predetermined gap and causing the coupling part to follow the upper surfaces.

Here, the aforementioned “edge-wise manner” refers to a winding method of longitudinally winding the rectangular wire one surface on the side of the short sides of the rectangular section of the rectangular wire used as an inner diameter surface and laminating the rectangular wire in a plate form, and the aforementioned “flat-wise manner” refers to a folding method of folding the rectangular wire in the direction of the side of the long side with one surface on the side of the long sides of the rectangular section of the rectangular wire used as an inner diameter surface.

### Advantageous Effect of Invention

According to the coil component, the coil device, and the method for producing the coil component of the present invention, the coupling part coupling the two coil elements is disposed to follow the upper surfaces of the two coil elements with a predetermined gap separated from the upper surfaces, and there is no room to get in between the two coil elements. Particularly, although the twisted section is formed at the coupling part of the two coil elements when the one long coil element is folded into two at a midpoint to form the two coil elements, the twisted section at the coupling part is disposed to follow the upper surfaces of the coil elements with the predetermined gap separated from the upper surfaces in the present invention, it is thus possible to narrow the gap between the two coil elements to the limit, a projecting part of the coupling part in the length direction (axial direction) of the two coil elements is also eliminated, and therefore, size reduction in the length direction can also be promoted.

Also, although heat generation cannot be avoided if a leakage magnetic flux continuously hits the twisted section at the coupling part, disposition of the twisted section at the coupling part on the front side between the two coil elements is avoided according to the coil component, the coil device, and the method for producing the coil component of the present invention, the risk of the leakage magnetic flux hitting the twisted section is reduced, and it is possible to significantly curb heat generation in a reactor of a magnetic coupling type, in particular.

Also, in the coil device of the present invention, there is no risk of an unnecessary space being generated since the twisted section at the above coupling part is not located between the coil elements and an inner wall surface of the core, and it is possible to reduce the size of the core shape and to achieve size reduction of the device.

### BRIEF DESCRIPTION OF DRAWINGS

FIG. 1 is a perspective view of a coil component according to an embodiment of the present invention.

FIG. 2 is a plan view illustrating a state of the coil component according to the embodiment in FIG. 1 seen from above.

FIG. 3 is a front view of the coil component according to the embodiment in FIG. 1.

FIG. 4 is a perspective view illustrating a main body of a coil device on which the coil component according to the embodiment in FIG. 1 is mounted.

FIG. 5 is a perspective view illustrating a main body of a coil device according to a modification of the embodiment illustrated in FIG. 4.

FIG. 6 is a perspective view illustrating a method for producing the coil component according to the embodiment in FIG. 1 (manufacturing step 1).

FIG. 7 is a perspective view illustrating the method for producing the coil component according to the embodiment in FIG. 1 (manufacturing step 2).

FIG. 8 is a perspective view illustrating the method for producing the coil component according to the embodiment in FIG. 1 (manufacturing step 3).

### DESCRIPTION OF EMBODIMENT

Hereinafter, a coil component according to an embodiment of the present invention will be described with reference to the drawings. The coil component according to the embodiment is applied to a reactor, for example.

The reactor is used as an electric circuit element for various apparatuses mounted in vehicles, for example, includes a magnetic core and a reactor coil wound around the core, and can typically accommodate a reactor main body with a reactor core inserted into the reactor coil in a case while securing insulation between the reactor main body and the case.

### Embodiment

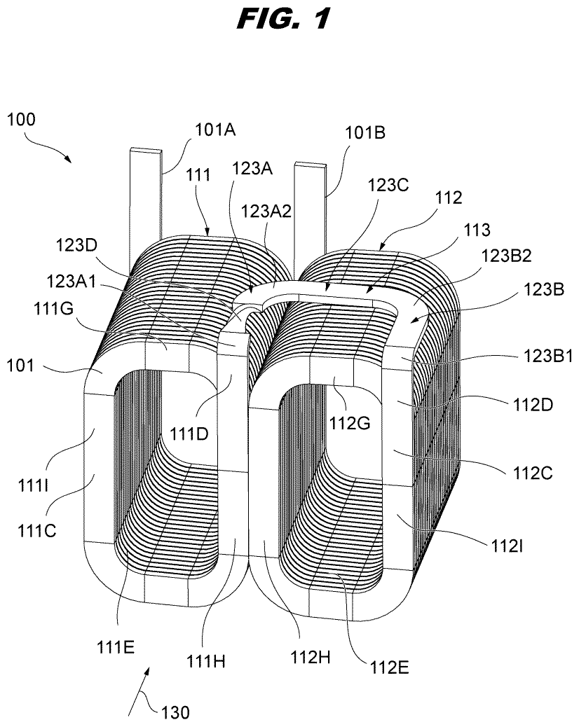

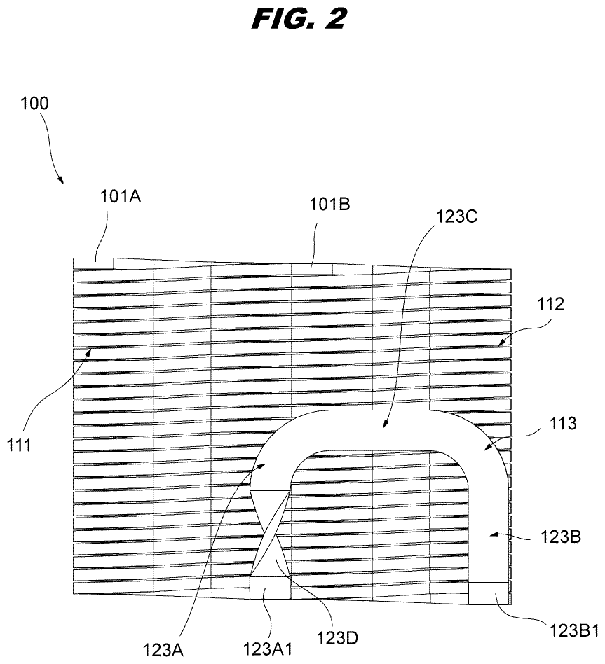

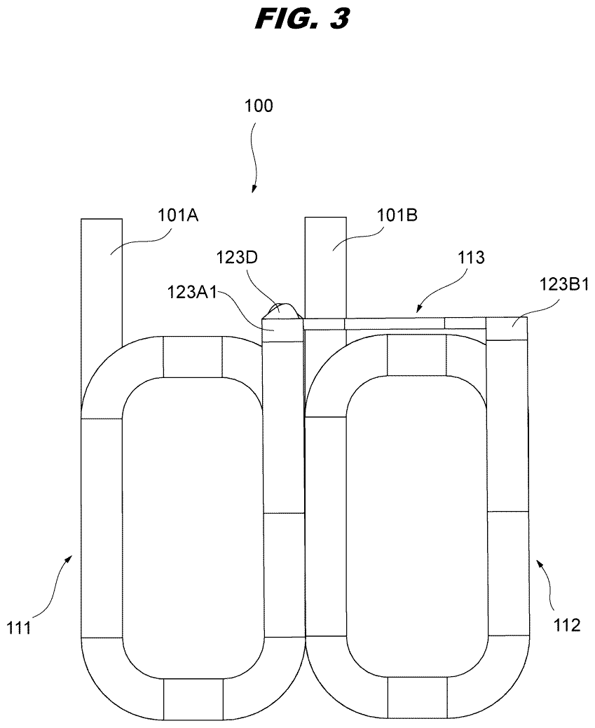

FIG. 1 is a perspective view illustrating a state of a coil component according to an embodiment of the present invention seen from a front obliquely upper side, FIG. 2 is a plan view illustrating a state of the coil component according to the embodiment in FIG. 1 seen from above, and FIG. 3 is a front view illustrating a state of the coil component according to the embodiment in FIG. 1 seen from the front.

A coil component 100 in the embodiment is configured to be provided with a first coil element 111 and a second coil element 112 each formed into an angular-tubular shape in parallel by winding one rectangular wire 101 in an edge-wise manner in one direction and laminating the rectangular wire 101 between one end portion 101A and the other end portion 101B which are connection terminals and folding the rectangular wire 101 into two at a predetermined position (typically at a substantially intermediate position) of the wound and laminated coil, and is configured to be provided with a coupling part 113 that couples both the coil elements 111 and 112 as illustrated in FIG. 1.

Also, the rectangular wire 101 has a rectangular cross section and is obtained by applying an insulation coating to a surface of a copper wire, for example.

Note that the above angular-tubular shapes of the coil elements are configured by lateral sides 111G and 112G in a direction parallel to an alignment direction connecting centers of the first coil element 111 and the second coil element 112 and longitudinal sides 111C and 112C in a direction perpendicularly intersecting the alignment direction.

The first coil element 111 and the second coil element 112 are disposed to be aligned such that one side surface of the first coil element 111 and one side surface of the second coil element 112 opposing each other are in substantially close contact with each other.

Also, the coupling part 113 includes a first connecting portion (a longitudinal side extended part of the first coil element) 123A, a second connecting portion (a longitudinal side extended part of the second coil element) 123B, and an intermediate part (a coupling part lateral side) 123C, the first connecting portion 123A includes a first flat-wise folded portion 123A1 and a twisted section 123D, and the second connecting portion 123B includes a second flat-wise folded portion 123B1.

Specifically, the above first connecting portion 123A is disposed to include the first flat-wise folded portion 123A1 where the rectangular wire 101 is folded at a right angle in a flat-wise fashion on the further side in FIG. 1 at a coil element winding end portion 111D of the first coil element 111 and has a portion that continues from the first flat-wise folded portion 123A1, follows the upper surface of the first coil element 111, and is directed to the further side in FIG. 1. Moreover, the twisted section 123D configured by twisting the rectangular wire 101 by 180 degrees is provided at a position in the first connecting portion 123A following the upper surface.

The above second connecting portion 123B is disposed to include a second flat-wise folded portion 123B1 where the rectangular wire 101 is folded at a right angle on the further side in FIG. 1 in a flat-wise fashion at a coil element winding start portion 112D of the second coil element 112 and has a portion that continues from the second flat-wise folded portion 123B1, follows the upper surface of the second coil element 112, and is directed to the further side in FIG. 1.

The above intermediate part 123C is a part that connects an end portion of the above first connecting portion 123A to an end portion of the above second connecting portion 123B and is disposed to extend in the same direction as the lateral sides 111G and 112G of the above coil elements 111 and 112. The intermediate part 123C includes edge-wise wound portions 123A2 and 123B2 that are folded in an edge-wise manner by 90 degrees with respect to the end portions of the connecting portions 123A and 123B, and is connected to the connecting portions 123A and 123B with the edge-wise wound portions 123A2 and 123B2, respectively.

In the coil component according to the embodiment, the coupling part coupling the first coil element 111 to the second coil element 112 is formed into a substantially big U shape including the first connecting portion 123A, the second connecting portion 123B, and the intermediate part 123C, and the part with the substantially big U shape is configured to follow the upper surfaces of the coil elements 111 and 112 as described above. Also, the coupling part 113 is connected to the coil element winding end portion 111D of the first coil element 111 and the coil element winding start portion 112D of the second coil element 112 via the flat-wise folded portions 123A1 and 123B1 folded on the further side in FIG. 1, and therefore, one portion of the coupling part 113 cannot project on the front side of the coil elements 111 and 112.

It is thus possible to easily prevent a failure in which a portion that straddles the first coil element 111 and the second coil element 112 is twisted and fitted between both of the coil elements 111 and 112 unlike the related art. It is also possible to promote size reduction of the coil elements 111 and 112 in the length direction.

It is thus possible to prevent an increase in size of the core.

Moreover, although heat is generated by a leakage magnetic flux continuously hitting the twisted section of the coupling part 113, disposition of the twisted section 123D of the coupling part in front of the two coil elements 111 and 112 is avoided in the coil component according to the embodiment, and it is thus possible to significantly curb the leakage magnetic flux hitting the twisted section 123D and to significantly curb heat generation in a reactor of a magnetic coupling type, in particular.

Although the coupling part 113 couples the coil element winding end portion 111D located on an inner longitudinal side 111H of the first coil element 111 to the coil element winding start portion 112D located on an outer longitudinal side 112I of the second coil element 112 in the embodiment, the coupling part 113 may couple a coil element winding end portion located on an outer longitudinal side 111I of the first coil element 111 to a coil element winding start portion located on an inner longitudinal side 112H of the second coil element 112 (the coil winding direction is opposite to that in the embodiment illustrated in FIG. 1).

Additionally, the one end portion 101A and the other end portion 101B are disposed to stand upright in the upward direction in the drawing, and the coupling part 113 is disposed on the upper surfaces of the coil elements 111 and 112 in the embodiment. Although it is possible to set the aforementioned one end portion 101A and the other end portion 101B to stand upright in a direction opposite thereto (from the lower surface side in FIG. 1), the coupling part 113 is provided on the opposite direction side (the lower surface side in FIG. 1) of the coil elements 111 and 112 in this case.

In this manner, the coupling part 113 can be accommodated in a space in the height direction of the coil elements 111 and 112 (a space generated by providing the one end portion 101A and the other end portion 101B), and an increase in size of the coil component in the height direction (up-down direction) is thus not problematic.

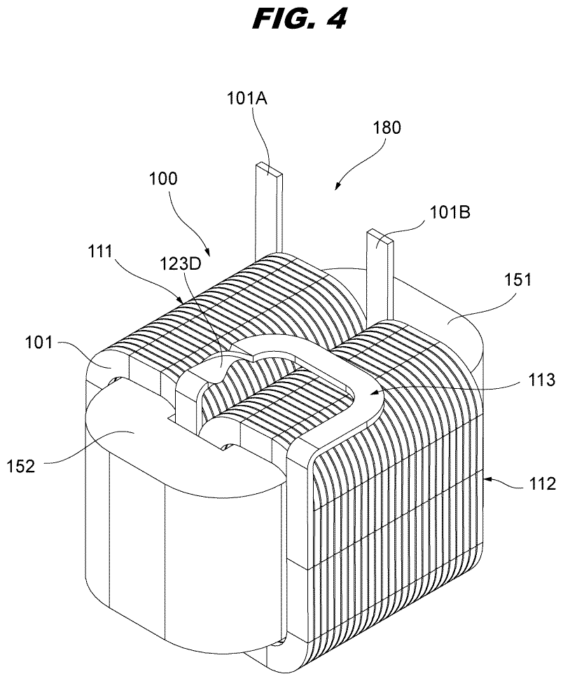

When a coil device (reactor) is configured by using the coil component 100 illustrated in FIG. 1, a coil device (reactor) 180 is configured by inserting left and right leg parts of a pair of U-shaped cores 151 and 152 into hollow parts 111E and 112E of the two coil elements 111 and 112 as illustrated in FIG. 4 and causing the left and right leg parts to abut each other inside the hollow parts 111E and 112E.

With this configuration, there is no risk of inhibiting size reduction of the coil device in the length direction (an axial direction of the coil elements) as in the related art in which the twisted section is located between the coil elements 111 and 112 and the inner wall of the U-shaped core 152.

Note that the reactor main body 180 is typically accommodating in a casing or the like made of metal via an insulating material (not illustrated).

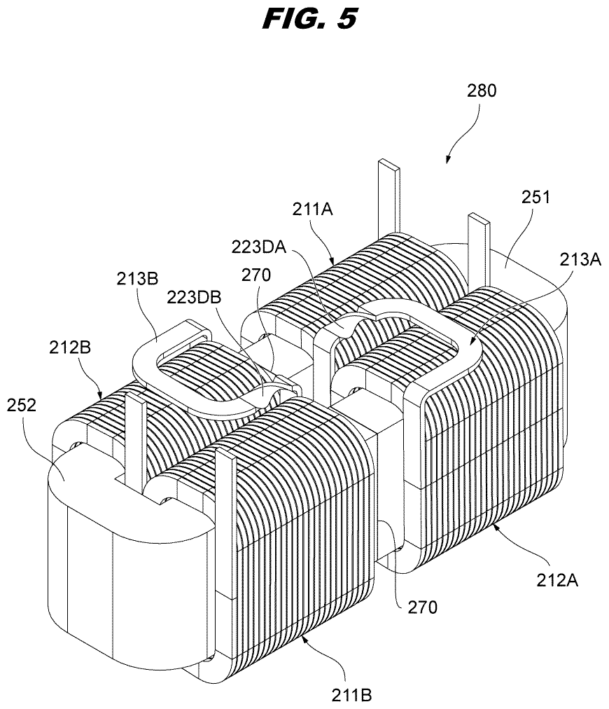

Also, FIG. 5 illustrates a coil device 280 of a magnetic coupling type according to an embodiment that is different from the coil device 180 illustrated in FIG. 4.

The coil device 280 illustrated in FIG. 5 is configured such that one coil component 100 (see FIG. 1) is fitted and inserted into each of U-shaped cores 251 and 252 and leg parts of the U-shaped cores 251 and 252 are caused to abut each other. Although a large leakage magnetic flux may be generated from a clearance 270 between the cores 251 and 252 in the region where the leg parts of the U-shaped cores 251 and 252 are caused to abut each other in this case, it is possible to curb the leakage magnetic flux hitting twisted sections 223DA and 223DB and to curb heat generation at this portion in this case as well according to the coil component and the coil device of the embodiment since the twisted sections 223DA and 223DB of a rectangular wire 101 (see FIG. 1) at the coupling parts 213A and B are configured to be located above the upper surfaces of the coil elements 211A, B, 212A, and B.

Also, although inductance properties of a product are typically adjusted by connecting cores with a gap formed of an insulating substance or the like when the cores are combined (a magnetic path is configured by combining I-shaped cores, for example), a magnetic flux radially leaks from the gap between the cores, and in the case of the aforementioned related art, the leakage magnetic flux hits the twisted section of the rectangular wire at the coupling part, generates heat, and leads to a loss. According to the coil component and the coil device in the embodiment, it is possible to curb the leakage magnetic flux hitting the twisted sections 223DA and 223DB and to curb heat generation at this portion in this case as well.

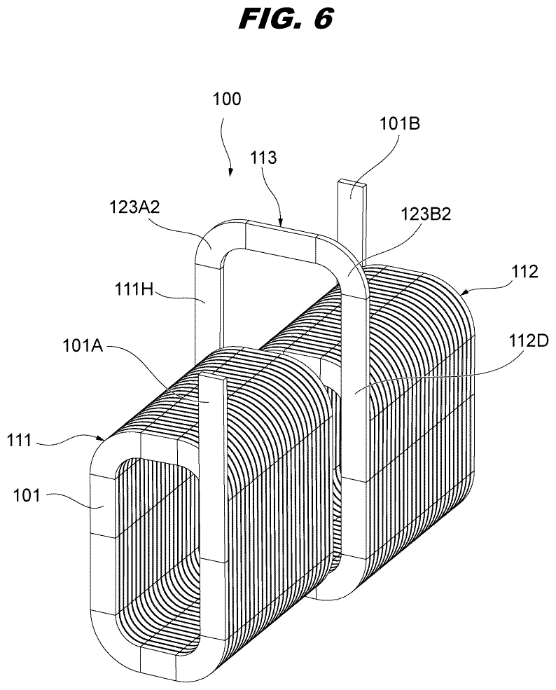

FIGS. 6 to 8 are views showing steps of a manufacturing method illustrating a method of producing the coil component according to the embodiment.

First, when the two coil elements 111 and 112 are wound and formed by using the one rectangular wire 101 as illustrated in FIG. 6, one winding between the two coil elements 111 and 112 is caused to slightly project upward in the drawing as illustrated in FIG. 6, and a state where the outer diameter of only the one winding in the upward direction is enlarged is obtained (manufacturing step 1: coil element forming step).

Note that winding directions of the two coil elements 111 and 112 are the same.

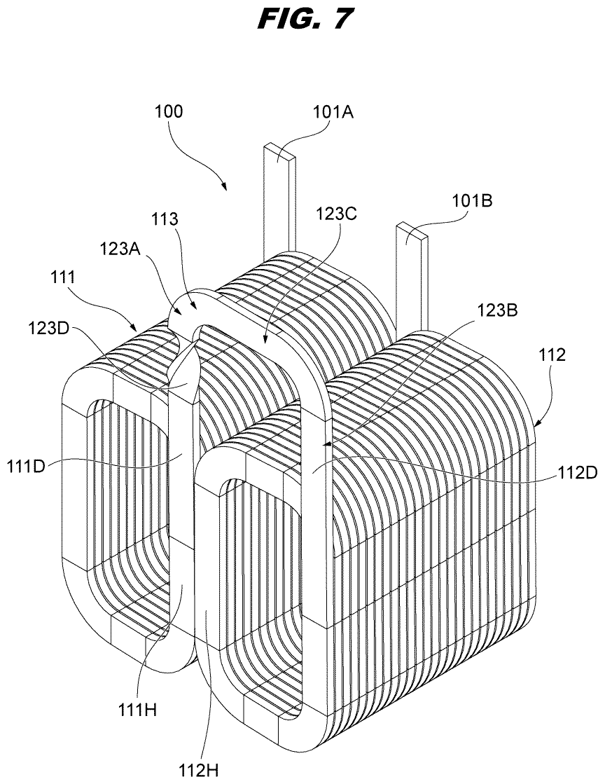

Next, the first coil element 111 and the second coil element 112 are folded into a two-folded form in a direction perpendicularly intersecting the alignment direction and are formed in a split manner with the rectangular wire 101 twisted by 180 degrees (the twisted section 123D is formed) at a predetermined position in the first connecting portion 123A at a position of the coupling part 113 as illustrated in FIG. 7 (manufacturing step 2: coil element splitting step).

In other words, the first coil element 111 and the second coil element 112 are mutually rotated by 180 degrees in a clockwise direction seen from the side of the upper surfaces in the drawing around the longitudinal side 111H including the coil element winding end portion 111D of the first coil element 111 from the state illustrated in FIG. 6, and the state illustrated in FIG. 7 is set. At this time, the twisted section 123D is formed at the predetermined position of the first connecting portion 123A.

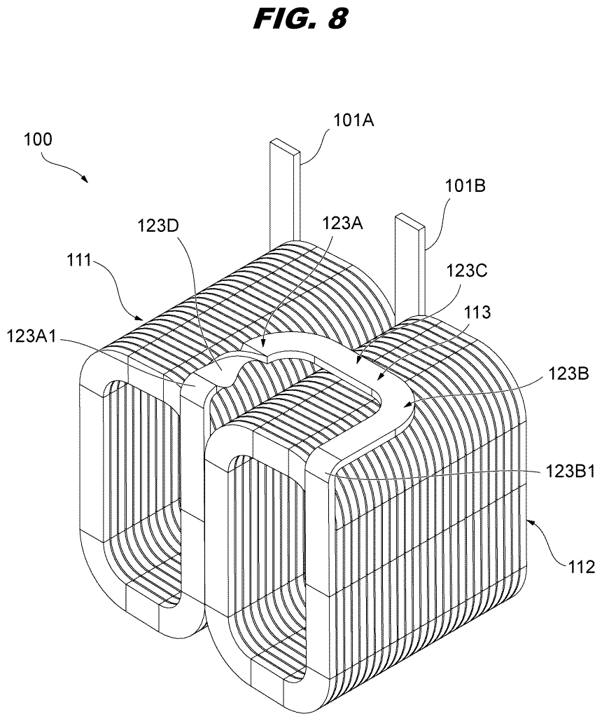

Next, the first connecting portion 123A and the second connecting portion 123B of the coupling part 113 are folded by 90 degrees on the further side in the drawing in a flat-wise manner at positions (flat-wise folded portions 123A1 and 123B1) mutually separated from the upper surfaces of the coil elements 111 and 112 by similar predetermined heights, such that the entire coupling part 113 is caused to follow the upper surfaces of the coil elements 111 and 112 as illustrated in FIG. 8 (manufacturing step 3: coupling part folding step).

Note that although the above “predetermined height position” can be at an arbitrary distance as long as the twisted section 123D is not sandwiched between the coil elements 111 and 112 in the state, the distance is preferably such a distance that enables a working jig or the like to be inserted between the coupling part 113 and the upper surfaces of the coil elements 111 and 112. In other words, it is possible to set an arbitrary distance between the coupling part 113 and the coil elements 111 and 112 in the coil component in the embodiment and thereby to easily perform bending and twisting in accordance with the condition.

It is possible to easily produce the coil component 100 with the coupling part 113 caused to follow the upper surfaces of the coil elements 111 and 112 by performing the manufacturing steps 1 to 3 in order.

Also, it is possible to adjust the length of the intermediate part 123C extending in the alignment direction of the two coil elements 111 and 112 and to thereby freely set a gap between the two coil elements 111 and 112. Therefore, it is also possible to set the gap to zero and to bring the two coil elements 111 and 112 into close contact with each other as in the aforementioned embodiment.

Note that the coil component and the coil device according to the present invention are not limited to those in the above embodiment, and other various modes can be employed. For example, although the intermediate part 123C of the coupling part 113 in the above embodiment is located above each of the coil elements 111 and 112 as described above, the intermediate part 123C may be located below each of the coil elements 111 and 112 in FIG. 1.

Also, although the U-shaped cores are used as cores in the embodiment illustrated in FIGS. 4 and 5, it is possible to use cores with other various shapes in the coil device according to the present invention, and it is a matter of course that a desired magnetic path can be configured by combining I-shaped cores, for example.

Additionally, although the method for producing the coil component has been described in the above embodiment, it is a matter of course that the method for producing the coil component is not limited thereto, and other various producing methods can be employed.

Also, although the coil component applied to an in-vehicle reactor has been described as the coil component according to the above embodiment, the coil component, the coil device, and the method for producing the coil component according to the present invention can be applied not only to an in-vehicle application but also to various applications, and for example, it is also possible to apply the coil component, the coil device, and the method for producing the coil component to a reactor and the like used in a photovoltaic power generation panel.

### REFERENCE SIGNS LIST

100 Coil component
101 Rectangular wire
101A, B End portion
111, 211A, B First coil element
111C, 112C Longitudinal side
111D Coil element winding end portion
111E, 112E Hollow part
111G, 112G Lateral side
111H, 112H Inner longitudinal side
111I, 112I Outer longitudinal side
112, 212A, B Second coil element
112D Coil element winding start portion
113, 213A, B Coupling part
123A First connecting portion
123A1, 123B1 Flat-wise folded portion
123A2, 123B2 Edge-wise wound portion
123B Second connecting portion
123C intermediate part
123D, 223DA, 223DB Twisted section
151, 152, 251, 252 U-shaped core
180, 280 Coil device (reactor)
270 Clearance

1. A coil component comprising:
a first coil element and a second coil element that are formed from a winding coil divided into two and folded back at a predetermined position with opposing side surfaces disposed to be parallel with each other, the winding coil being formed by rectangularly laminating one rectangular wire in an edge-wise manner; and
a coupling part that couples both the coil elements,
wherein for the coupling part, when, in end surfaces related to the coupling between the first coil element and the second coil element, a side of the first coil element and a side of the second coil element adjacent to each other among each of sides of a rectangular part configuring the end surfaces of each of the coil elements, and sides that are parallel to the sides, are referred to as first sides,
the coupling part is for coupling a coil element winding end portion located in a vicinity of an end portion of one of the first sides of one of the two coil elements or on an extension of the first side with a coil element winding start portion located in a vicinity of an end portion of one of the first sides of the other one of the two coil elements or on an extension of the first side, and
the coupling part is disposed to straddle the first coil element and the second coil element by being caused to follow upper surfaces of the two coil elements with a predetermined gap from the upper surfaces, and is configured to include a twisted section where the rectangular wire is twisted by 180 degrees at one portion of the coupling part.

2. The coil component according to claim 1,
wherein for the coupling part, when the first sides of the first coil element and the second coil element located on an inner side are referred to as inner first sides, and the first sides located on an outer side are referred to as outer first sides,
the coupling part is for coupling one of a coil element winding start portion and a coil element winding end portion located in a vicinity of an end portion of one of the inner first side of one of the two coil elements or on an extension of the inner first side with the other one of the coil element winding start portion and the coil element winding end portion located in a vicinity of an end portion of one of the outer first side of the other one of the two coil elements or on an extension of the outer first side.

3. The coil component according to claim 2, wherein the coupling part includes two sides in a length direction of the first coil element and the second coil element and one side in an alignment direction of the coil elements, the two sides having a predetermined length and extending in an axial direction of the coil elements via flat-wise folded portions from the coil element winding start portion and the coil element winding end portion on upper surfaces of the coil elements, the one side connecting end portions of the two sides in the length direction, the twisted section being provided on a side extending from the inner first side out of the two sides in the length direction.

4. The coil component according to claim 1, wherein in the first coil element and the second coil element, end portions of the rectangular wire on sides opposite to the coupling part are formed to extend upward from a side of the upper surface.

5. The coil component according to claim 1, wherein opposing side surfaces of the first coil element and the second coil element are configured to be in close contact with each other.

6. A coil device comprising:
the coil component according to claim 1; and
a magnetic core part with leg parts inserted into hollow parts of the coil component to form a closed magnetic path as a whole.

7. A method for producing a coil component including a first coil element and a second coil element that are formed into angular-tubular shapes in a mutually aligned manner by using one rectangular wire with both end portions serving as connection terminals and laminating portions in vicinities of both the end portions in an edge-wise manner, and a coupling part that couples both the coil elements, opposing one side surface of the first coil element and one side surface of the second coil element being disposed to be parallel with each other, the method comprising,
in a case where sides configuring the angular-tubular shapes are referred to as lateral sides in a direction parallel with an alignment direction connecting centers of the first coil element and the second coil element and as long sides in a direction perpendicularly intersecting the alignment direction in a state where the coil component is produced:
a first coil element forming step of forming the first coil element into an angular-tubular shape by winding and laminating the rectangular wire in an edge-wise manner including the longitudinal sides and the lateral sides from a vicinity of an end portion of the first coil element of the rectangular wire;
a coupling part forming step of forming a longitudinal side extended part of the first coil element by causing the rectangular wire to stick out in an outer diameter direction of the angular-tubular shape to extend the longitudinal side from a winding terminating end of the first coil element, further forming a coupling part lateral side that is parallel with the lateral sides by folding the longitudinal side extended part by 90 degrees in an edge-wise manner to be directed to an upper surface of the second coil element, and then forming a longitudinal side extended part of the second coil element to be parallel with the longitudinal side extended part of the first coil element and continue to a winding start end of the second coil element by folding the coupling part lateral side by 90 degrees toward the second coil element in an edge-wise manner;
a second coil element forming step of forming the second coil element into the angular-tubular shape by winding and laminating the rectangular wire in a same direction as a winding direction of the first coil element up to a vicinity of the other end portion in an edge-wise manner including the longitudinal sides and the lateral sides at a position where the second coil element is produced, each of the steps being performed in this order;
a coil element splitting step of subsequently twisting the longitudinal side extended part of the first coil element by 180 degrees at a position of the coupling part and folding back the first coil element and the second coil element in a mutually two-folded form in a direction perpendicularly intersecting the alignment direction; and
a coupling part folding step of then folding the longitudinal side extended part of the first coil element and the longitudinal side extended part of the second coil element by 90 degrees in a flat-wise manner at positions mutually separated from upper surfaces of the first coil element and the second coil element by a predetermined gap and causing the coupling part to follow the upper surfaces.
